(19) United States
(12) Patent Application Publication
(10) Pub. No.: US 2003/0167696 A1
(43) Pub. Date: Sep. 11, 2003

(54) Gate for the entry of a gateway for stopping the flow water

(76) Inventor: Shih-Hsin Chen, Taipei City (TW)

Correspondence Address: BACON & THOMAS, PLLC, 625 SLATERS LANE, FOURTH FLOOR, ALEXANDRIA, VA, 22314

(21) Appl. No.: 10/092,430

(22) Filed: Mar. 8, 2002

(51) Int. Cl. E02B 7/20; E02B 7/00; E06B 7/18

(52) U.S. Cl. 49/477.1; 405/87; 405/92

(57) ABSTRACT

A gate is constructed to include a casing mounted in the ground of a gateway entry, two hollow posts fixedly fastened to two opposite sidewalls of the gateway entry and connected to the ends of the casing, an inflatable shutter received in the casing, an air pump selectively controlled to pump air into/out of the inflatable shutter, and detector switch means adapted to drive the air pump to pump air into the inflatable shutter, for lifting the inflatable shutter between the hollow posts to stop the flow of water upon a flood of rain.

### BACKGROUND OF THE INVENTION

1. Field of the Invention

The present invention relates to a gate and, more specifically, to a gate for the entrance of a gateway that is automatically controlled to stop the flow of water upon a flood of rain.

2. Description of the Related Art

When it rains heavily, rainwater may cover low-lying places and entered the entry of a gateway or parking lot. In order to stop the flow of rainwater from entering the gateway or parking lot, people may lay sandbags on the entry of the gateway or parking lot to give protection from floodwater. However, it takes much time and labor to prepare sandbags and to carry prepared sandbags to the desired place. Further, sandbags cannot completely stop the permeation of the flow of water. After each use, it takes much time and labor to carry sandbags away from the entry of the gateway or parking lot and to clean the entry.

### SUMMARY OF THE INVENTION

The present invention has been accomplished under the circumstances in view. It is one object of the present invention to provide a gate for the entrance of a gateway, which is automatically controlled to stop the flow of water upon a flood of rain. It is another object of the present invention to provide a gate for the entry of a gateway, which does not interfere with the vehicles passing through the gateway entry when received. According to one aspect of the present invention, the gate comprises a casing mounted in the ground of a gateway entry, two hollow posts fixedly fastened to two opposite sidewalls of the gateway entry and connected to the ends of the casing, an inflatable shutter received in the casing, an air pump selectively controlled to pump air into/out of the inflatable shutter, and detector switch means adapted to drive the air pump to pump air into the inflatable shutter, for lifting the inflatable shutter between the hollow posts to stop the flow of water upon a flood of rain. According to another aspect of the present invention, the casing has two top flanges disposed in flush with the ground of the gateway entry and defining a shutter passage through which the inflatable shutter is extended out and lifted between the hollow posts when inflated. According to still another aspect of the present invention, the inflatable shutter comprises a plurality of sleeves transversely extended through two opposite lateral sides, and a plurality of reinforcing bars respectively mounted in the sleeves to reinforce the structural strength of the inflatable shutter when inflated.

### BRIEF DESCRIPTION OF THE DRAWINGS

FIG. 1 is an exploded view of a gate according to a first embodiment of the present invention.

FIG. 2 is a perspective view of the first embodiment of the present invention showing the gate installed in a gate entry.

FIG. 3 is a schematic drawing of the first embodiment of the present invention showing the inflatable shutter collapsed and received in the casing.

FIG. 4 is a schematic drawing of the first embodiment of the present invention showing the inflatable shutter inflated and lifted between the hollow posts.

FIG. 5 is a top plain view of the first embodiment of the present invention after the inflatable shutter inflated.

FIG. 6 is a top plain view of the casing for the gate according to a second embodiment of the present invention.

FIG. 7 is a perspective view of the second embodiment of the present invention, showing the inflatable shutter inflated and lifted between the hollow posts.

FIG. 8 is a top plain view of a gate according to a third embodiment of the present invention, showing the inflatable shutter inflated.

### DETAILED DESCRIPTION OF THE PREFERRED EMBODIMENT

Referring to FIGS. from 1 through 3, a gate in accordance with the present invention is shown comprising a casing 1 mounted in a hole 511 in the ground 51 of a gateway entry 5 in a flush manner, two hollow posts 13 respectively connected to the two open ends of the casing 1 and fixedly fastened to the two opposite sidewalls 52 of the gateway entry 5, and an inflatable shutter 2 received in the casing 1. The casing 1 has two horizontal top flanges 12 bilaterally disposed at the top and defining a narrow top shutter passage 121. The hollow posts 13 each have a vertical shutter passage 131 disposed at an inner side in communication with the top shutter passage 121 of the casing 1. When inflating the inflatable shutter 2 with compressed air upon a flood of rain, the shutter 2 is lifted out of the top shutter passage 121 of the casing 1 and moved along the vertical shutter passages 131 of the hollow posts 13 to a certain height to stop the flow of water from passing through the gateway entrance 5. The inflatable shutter 2 comprises a plurality of transverse sleeves 21, a plurality of reinforcing bars 22 respectively mounted in the transverse sleeves 21, and an air valve 23 disposed at one end of the bottom side. An air pump 3 is provided at the top side of one hollow post 13, having an air nozzle 31 extended from one end thereof and connected to the air valve 23 of the inflatable shutter 2. A detector switch 4 is mounted in the hole 511 and electrically connected to the air pump 3, and adapted to detect water level in the hole 511 and to drive the air pump 3.

Referring to FIGS. from 3 through 5, normally, the inflatable shutter 2 is collapsed and arranged in the casing 1, and the horizontal top flanges 12 of the casing 1 are disposed in flush with the ground 51 of the gateway entry 5 without interfering with the passing of motor vehicles through the gateway entry 5. When rainwater entered the hole 511 in the ground 51 of the gateway entry 5 and reached to a certain level upon a flood of rain, the detector switch 4 is induced to output a first control signal to the air pump 3, thereby causing it to pump air into the inflatable shutter 2, and therefore the inflatable shutter 2 is inflated into shape and lifted along the vertical shutter passages 131 of the hollow post 13 to stop the flow of water. When the shutter 2 fully extended out, the reinforcing bars 22 are stopped between the hollow posts 13 at different elevations to reinforce the structural strength of the inflated shutter 2. When the flood of rain ended and water drained away, the detector switch 4 is induced to output a second control signal to the air pump 3, thereby causing it to draw air out of the shutter 2. When the shutter 2 collapsed, it falls with the reinforcing bars 22 into the inside of the casing 1.

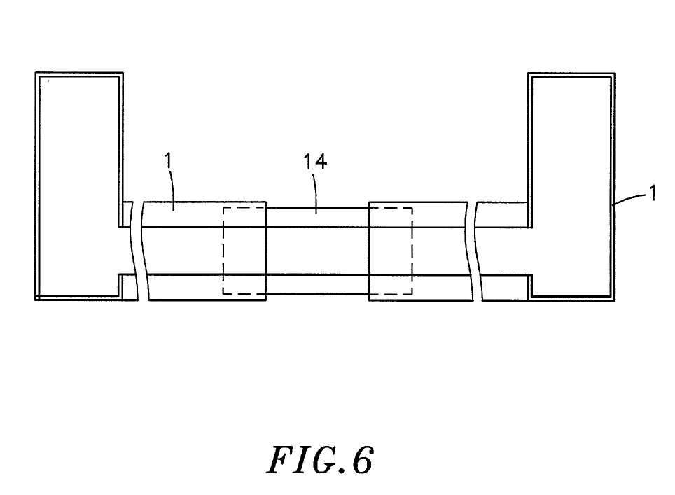

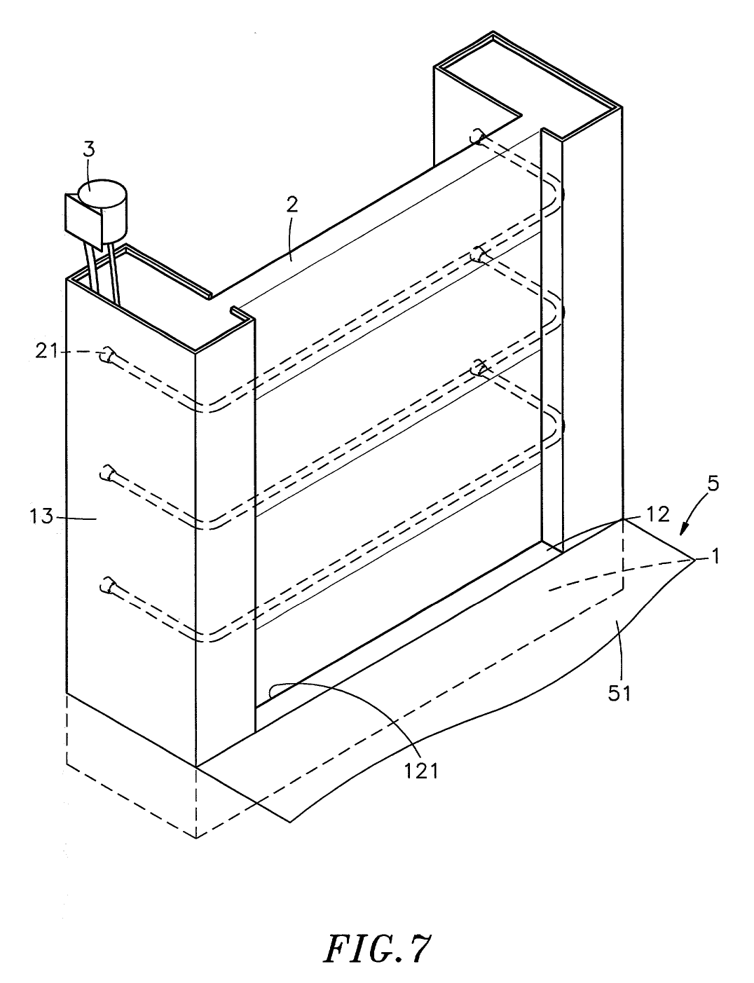

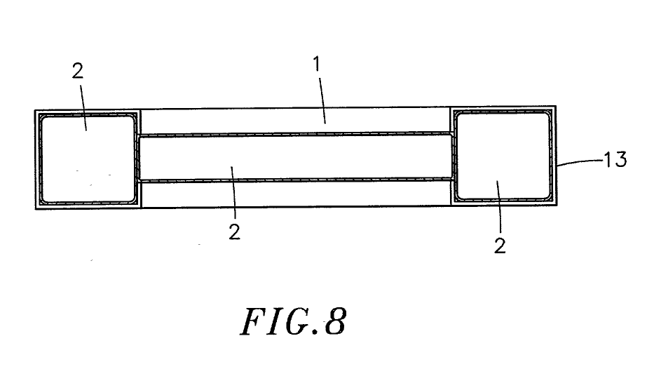

FIGS. 6 and 7 show an alternate form of the present invention. This design is suitable for use in a canal, etc to stop the flow of water. According to this alternate form, the casing 1 is comprised of two symmetrical parts axially slidably coupled together by a coupling 14. Therefore, the user can adjust the length of the casing 1 subject to the width of the canal in which the gate is to be installed. The air pump 3 is preferably designed to work with AC power supply as well as DC power supply. When AC power supply fails, battery power supply is used to provide the necessary working voltage to the air pump 3.

FIG. 8 shows still another alternate form of the present invention. According to this alternate form, the inflatable shutter 2 is formed of three independent air chambers each having a respective air valve 23 respectively connected to a respective air nozzle 31 extended from the air pump 3. In this case, the inflatable shutter 2 can still function well if one independent air chamber leaks.

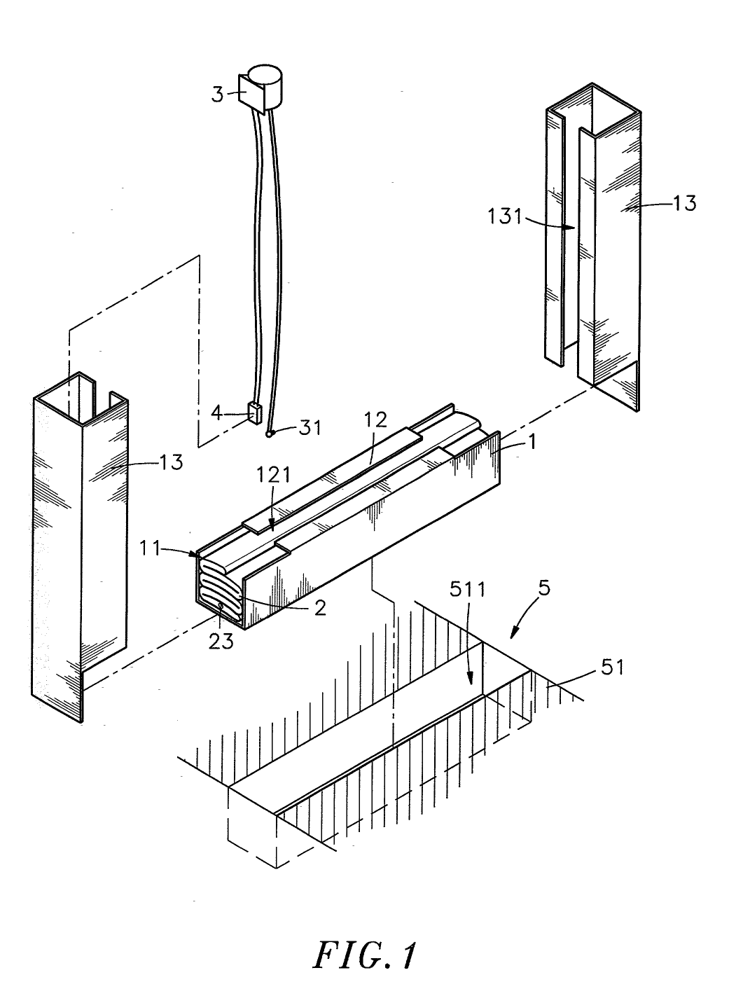

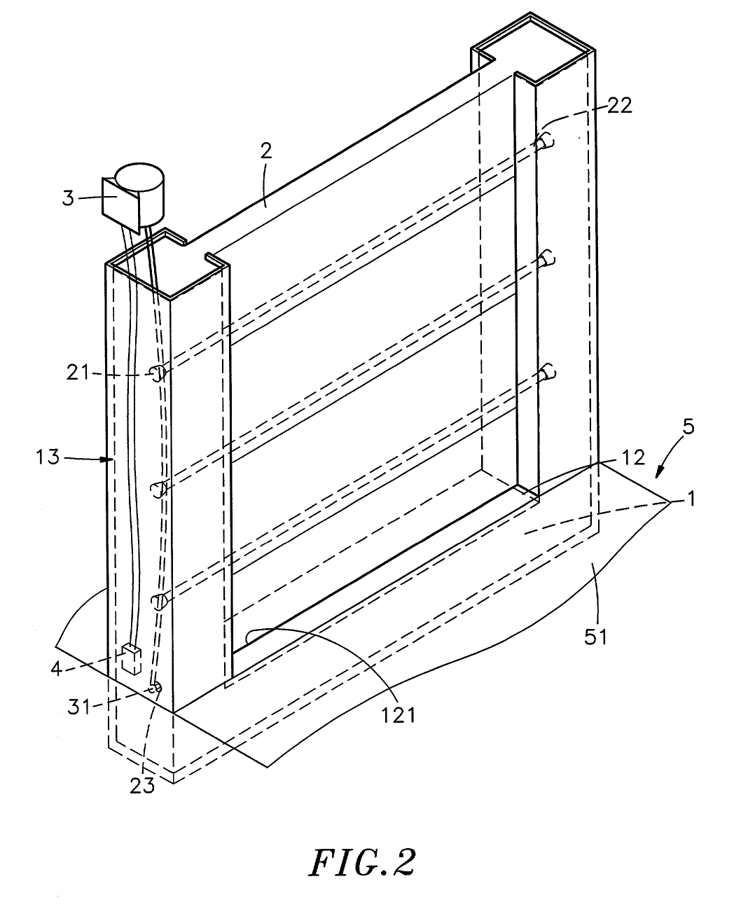

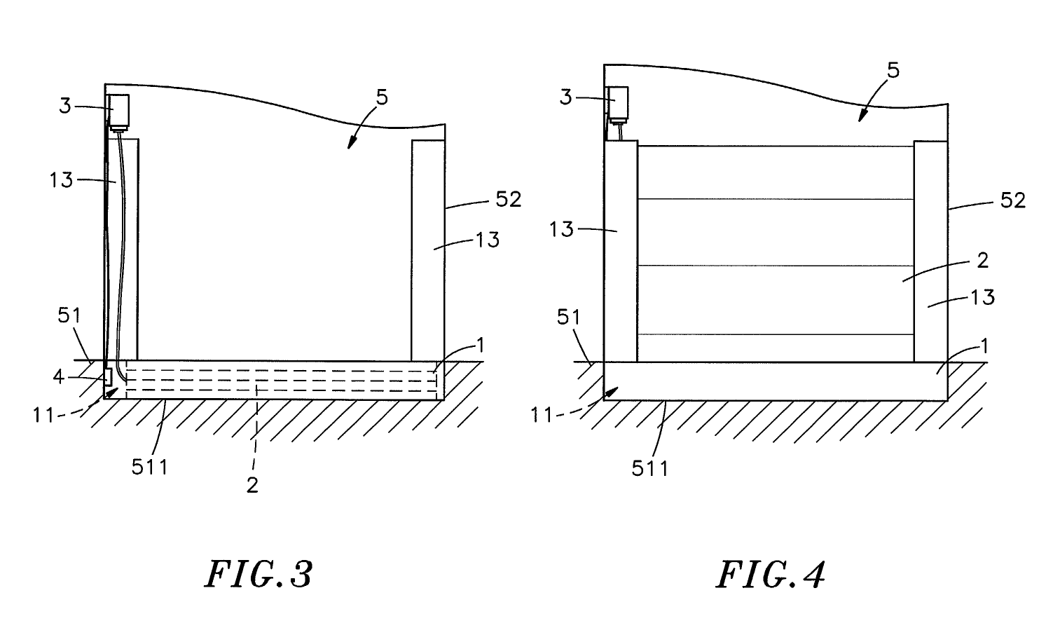

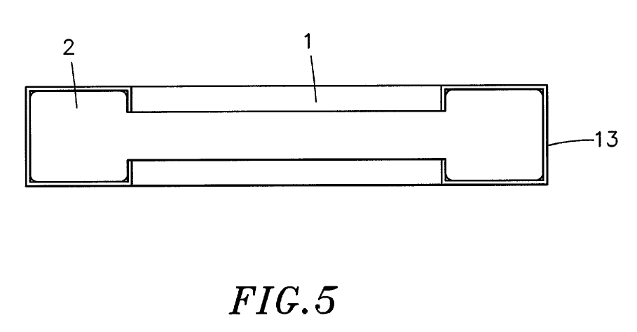

A prototype of gate has been constructed with the features of the annexed drawings of FIGS. 1˜8. The gate functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A gate installed in a gateway entry and controlled to stop water from passing through said gateway entry, comprising:
a casing horizontally disposed at a bottom side, said casing having two opposite open ends and a top shutter passage;
two hollow posts perpendicularly connected to two opposite open ends of said casing, said hollow posts each having a vertical shutter passage disposed at an inner side in communication with the top shutter passage of said casing;
an inflatable shutter received in said casing and adapted to stop the flow of water from passing through said gateway entry when inflated, said inflatable shutter having a fixed bottom side fixedly mounted in said casing and at least one air valve;
an air pump selectively controlled to pump air into/out of the at least one air valve of said inflatable shutter to inflate/collapse said inflatable shutter; and
detector switch means adapted to drive said air pump to pump air into said inflatable shutter, for lifting said inflatable shutter out of the top shutter passage of said casing and upwardly along the shutter passages of said hollow post to stop the flow of water upon a flood of rain when water accumulated at said gateway entry over a predetermined level, and to drive said air pump to draw air out of said inflatable shutter, for enabling said inflatable shutter to be collapsed and received in said casing when water accumulated at said gateway entry dropped below said predetermined level.

2. The gate as claimed in claim 1, wherein said casing is mounted in a hole in the ground of said gateway entry.

3. The gate as claimed in claim 2, wherein said casing has two top flanges horizontally disposed at a top side thereof in flush with the ground of said gateway entry and defining said top shutter passage.

4. The gate as claimed in claim 3, wherein said hollow posts are respectively fixedly fastened two opposite lateral sidewalls of said gateway entry, each having a bottom end respectively connected to the two opposite open ends of said casing.

5. The gate as claimed in claim 1, wherein said inflatable shutter comprises a plurality of sleeves transversely extended through two opposite lateral sides thereof, and a plurality of reinforcing bars respectively mounted in said sleeves.

6. The gate as claimed in claim 1, wherein said casing is comprised of two symmetrical parts axially slidably coupled together by a coupling for enabling the user to adjust the length of said casing subject to the width of said gateway entry.

7. The gate as claimed in claim 1, wherein said inflatable shutter comprises a plurality of independent air chambers, and a plurality of air valves respectively installed in said independent air chambers.
